(19) United States
(12) Patent Application Publication
(10) Pub. No.: US 2024/0076212 A1
(43) Pub. Date: Mar. 7, 2024

(54) ACID MINE DRAINAGE TREATMENT

(71) Applicant: University of Venda, Thohoyandou (ZA)

(72) Inventors: Nikita Tavengwa, Louis Trichardt (ZA); Vhahangwele Masindi, Thohoyandou (ZA); Collen Nepfumbada, Thohoyandou (ZA)

(21) Appl. No.: 17/939,870

(22) Filed: Sep. 7, 2022

(51) Int. Cl. C02F 1/52; C02F 1/62; C02F 11/13

(52) U.S. Cl. CPC C02F 1/5236; C02F 1/62; C02F 11/13; C02F 2101/20

(57) ABSTRACT

A method of treating acid mine drainage with calcium phosphate comprising acid mine drainage with a treatment agent including a compound comprising a phosphate under conditions that favour removal of contaminants from the acid mine drainage, thus forming the treated acid mine drainage that has concentration of contaminants which is less than the concentration of the contaminants in the acid mine drainage prior to the treatment.

### FIELD OF INVENTION

This invention is in the field of water treatment, in particular to the treatment of municipal waste water. The invention extends to a method of recovering phosphates from the waste water and use thereof in the treatment of acid mine drainage.

### BACKGROUND

The ever-increasing contamination of terrestrial and aquatic ecosystems by acid mine drainage and municipal wastewater streams has been an issue of topical concern to national, regional and international scientific communities, stakeholders, consortiums, concerned groups, and environmental organisations (The United Nations., 2018). This problem has been perpetual for the past decades particularly for countries with strong mining activities and rapid population growth. Furthermore, various technologies have been developed for the treatment of effluents emanating from domestic (municipal) wastewater (MWW) and acid mine drainage (AMD) but the challenge is residual impacts, poor efficacy, viability in terms of implementation, costs pertaining the technology, and availability of reagents (Masindi et al., 2019, Akinwekomi et al., 2020, Mavhungu et al., 2020a, Mavhungu et al., 2020b). The drawbacks of conventional technologies and stringent regulatory frameworks brought dawn to innovative ways to manage wastewater effluents. According to the UN-goals, the concept of wastewater valorisation through the recovery and beneficiation of waste has been the most interesting approach in the treatment of municipal wastewater (Masindi and Foteinis, 2021). This will ensure that a circular approach is meticulously met in wastewater management (Rosemarin et al., 2020, Singh et al., 2020).

Acid mine drainage comprise elevated levels of inorganic contaminants such as Fe, Al, Mn, heavy metals (such as Cu, Ni, and Zn), metalloids, oxyanions, radionuclides, rare earth metals and high acidity (Simate and Ndlovu, 2014, Kefeni et al., 2017, Park et al., 2019). However, reaction of this biorecalcitrant is mediated by Fe and S-based bacteria communities. The physicochemical properties of AMD depends on the host geology being weathered, for instance, AMD from pyrite (FeS₂) oxidation results in AMD that is rich in Fe and sulphate and yet the case is similar to other predominant sulphide bearing minerals (Baker and Banfield, 2003, Sheoran et al., 2011, Wei et al., 2016). On the same note, municipal wastewater constitute elevated levels of chemical oxygen demand (COD), phosphate, ammonia, and notable base metals amongst microbiological constituents (Petrie et al., 2015, Arola et al., 2019, Mavhungu et al., 2020a). Contaminants available in both streams are pollutants of major concern to the receiving environment and they need to be removed from effluents prior discharge to the environment (Masindi et al., 2022). Specifically, metals embodied in AMD poses eco-toxicological effects to living organisms on exposure whilst chemicals in municipal wastewater can cause eutrophication to the receiving environment and this will then lead to oxygen depletion and alteration of aesthetic values (Ghabris et al., 1989, Bouwer, 2000, Soucek et al., 2000, Ye et al., 2017, Amann et al., 2018).

To effectively curtail potential impacts of contaminants embodied in AMD and MWW, regulatory frameworks require these effluents to be treated before they could be discharged into the environment (Ansari et al., 2017, Arola et al., 2021, Masindi et al., 2022). Various technologies have been developed for the treatment of AMD and MWW (Sahoo et al., 2013, Simate and Ndlovu, 2014, Mavhungu et al., 2020b). Specifically, active and passive treatment technologies are used for the treatment of AMD but owing to its efficacy and effectiveness, active treatment approach have been considered the best in mine water management. These technologies rely on the use of alkaline materials such as lime, hydrated lime, limestone, dolomite, magnesite, periclase, brucite, soda ash, and caustic soda amongst others (Kefeni et al., 2017, Naidu et al., 2019, Neculita and Rosa, 2019, Park et al., 2019). However, these are virgin materials and they run a risk of being depleted in the near future hence there is a need to find alternative sources of neutralising agents for active treatment. On the other hand, MWW has high concentration of phosphate and this could be recovered and beneficiated for mine water treatment (Mavhungu et al., 2019). Masindi et al. (2022) demonstrated the feasibility of calcium phosphate for the treatment of acidic effluents whilst their previous study demonstrated the feasibility of recovering phosphate via the synthesis of calcium phosphate [Ca3(PO4)2]. This makes a circular approach where minerals are recovered from wastewater and the product mineral is beneficiated for the treatment of AMD. This will then be the first study in design and execution to explore the novel application of calcium phosphate [Ca3(PO4)2] for the treatment of authentic AMD.

### SUMMARY

According to an aspect of the invention there is provided a method of treating acid mine drainage, the method including contacting acid mine drainage with a treatment agent including a compound comprising a phosphate, thus forming a mixture of the acid mine drainage with the treatment agent, wherein the contact of the acid mine drainage and the treatment agent occurs under conditions that favour the removal of contaminants from the acid mine drainage, thus forming treated acid mine drainage that has a concentration of contaminants which is less than the concentration of contaminants prior to treatment of the acid mine drainage.

The compound comprising the phosphate may be in a form of a synthesised (i.e. not naturally occurring) compound including calcium phosphate.

The contaminants in the acid mine drainage may include Fe, Al, Mn, heavy metals (such as Cu, Ni, and Zn), metalloids, oxyanions, radionuclides, rare earth metals and high acidity in the acid mine drainage.

The synthesised compound comprising calcium phosphate may be obtained from contacting a body of contaminated water, in particular municipal waste water comprising ammonia and phosphate, with a precipitation agent selected from a group consisting of lime, hydrated lime, limestone, dolomite, magnesite, periclase, brucite, soda ash, and caustic soda, preferably hydrated lime, under conditions that favour the precipitation of the synthesised compound comprising calcium phosphate from the municipal waste water.

The synthesised compound comprising calcium phosphate may be recovered from the municipal waste water in the form of a municipal waste water sludge. Accordingly, the method may include the step of separating the formed synthesised compound comprising calcium phosphate in the form of the municipal waste water sludge from the municipal waste water or treated municipal waste water or the combination of both, typically by using a solid-liquid separation technique. Accordingly, the municipal waste water sludge may accordingly be separated under gravity from the waste water or treated waste water or combination thereof, wherein the waste water or treated waste water or combination thereof may be recovered as supernatant solution and the municipal waste water sludge may be recovered for further treatment. The recovered municipal waste water sludge may accordingly be dried, typically under high temperature conditions, for example, in an oven, to form dried sludge. The dried municipal waste water sludge may be subjected to size reduction thus forming particles of the municipal waste water sludge comprising the synthesised compound comprising of calcium phosphate.

The favourable conditions which favour the removal of contaminants from the acid mine drainage may include contacting about 1 litre of acid mine drainage with between 0.5 g to 25 g, preferably 1 to 15 g, more preferably between 2.5 g and 10 g, more preferably 5 g and 10 g of synthesised compound comprising calcium phosphate with acid mine drainage, for a contact time of between 5 and 180 minutes, preferably 10 and 90 minutes, preferably between 15 and 60 minutes, more preferably between 30 and 45 minutes.

Preferably, the favourable conditions which favour the removal of contaminants from the acid mine drainage may include contacting about 1 litre of acid mine drainage with about 10g of synthesised calcium phosphate for a contact time of about 90 minutes.

The method may include the step of agitating, preferably continuously agitating, a mixture comprising the synthesised calcium phosphate with the acid mine drainage.

The agitation may be affected in a vessel containing an agitator, in a form of an overhead stirrer, arrange to rotate the mixture at a rotational speed of about 300 rpm.

The method may further comprise a step of recovering the treated water (i.e. treated acid mine drainage) from discard product that may form during the treatment of acid mine drainage. The discard product may be in the form of acid mine drainage sludge. The recovery of the treated acid mine drainage from the acid mine drainage sludge may be by using a solid-liquid separation technique in which the treated acid mine drainage is recovered from the acid mine drainage sludge as a supernatant solution.

According to a second aspect of the invention there is provided a process for treating acid mine drainage, the process including: feeding, in a vessel, acid mine drainage water and a synthesised compound comprising calcium phosphate to allow contact between the acid mine drainage and the synthesised compound comprising calcium phosphate, thus forming a mixture of the acid mine drainage and synthesised compound comprising calcium phosphate, wherein the contact between the acid mine drainage and synthesised compound comprising calcium phosphate occurs under contact conditions that favour the removal of contaminants from the acid mine drainage thus forming treated acid mine drainage that has a concentration of contaminants that is lower than the concentration of contaminants in the acid mine drainage prior to treatment.

The process may include the formation of acid mine drainage sludge comprising the contaminants removed from the acid mine drainage.

The process may further include recovering the treated acid mine drainage from the acid mine drainage sludge.

### BRIEF DESCRIPTION OF THE DRAWINGS

The solution will be described and explained with additional specific detail through the use of the accompanying drawings in which:

FIG. 1 shows variation in EC, pH, Ca, and Mg with an increase in contact time during the treatment of real AMD using the synthesized calcium phosphate (conditions: room temperature and pH, 10 g of dosage in 1000 mL, and 250 rpm mixing speed);

FIG. 2 shows variation in the percentage removal of chemical species (i.e. contaminant metal species) with an increase in contact time (conditions: room temperature and pH, 10 g of dosage in 1000 mL, and 250 rpm mixing speed);

FIG. 3 shows variation in EC, pH, Ca, and Mg with an increase in calcium phosphate dosage during the treatment of real AMD using the synthesized calcium phosphate (conditions: room temperature and pH, 90 minutes of equilibration, 1000 mL container, and 250 rpm mixing speed);

FIG. 4 shows variation in the percentage removal of chemical species with an increase in calcium phosphate dosage (conditions: room temperature and pH, 90 minutes of equilibration, 1000 mL container, and 250 rpm mixing speed);

FIG. 5(a) shows elemental composition of hydrated lime (CaO nanopowder);

FIG. 5(b) shows elemental composition of calcium phosphate;

FIG. 5(c) shows shows elemental composition of resultant sludge;

FIG. 6(a) shows the microstructural and morphological properties of CaO nanopowder (hydrated lime);

FIG. 6(b) shows elemental composition of calcium phosphate in magnification of 1 μm; 200 nm and 100 nm [FIG. 6(b, e, and h)]

FIG. 6(c) shows the product sludge after the interaction of calcium phosphate and real acid mine drainage comprised spherical particles connected to each other on a dendritic fashion;

FIG. 6(d) shows the microstructural and morphological properties of CaO nanopowder (hydrated lime);

FIG. 6(e) shows elemental composition of calcium phosphate in magnification of 200 nm; and 100 nm [FIG. 6(b, e, and h)]

FIG. 6(f) shows the product sludge after the interaction of calcium phosphate and real acid mine drainage comprised spherical particles connected to each other on a dendritic fashion;

FIG. 6(g) shows the microstructural and morphological properties of CaO nanopowder (hydrated lime);

FIG. 6(h) shows elemental composition of calcium phosphate in magnification of 100 nm;

FIG. 6(i) shows the product sludge after the interaction of calcium phosphate and real acid mine drainage comprised spherical particles connected to each other on a dendritic fashion;

FIG. 7(a) shows the SEM image and elemental maps of CaO nanopowder (hydrated lime);

FIG. 7(b) shows the SEM image and elemental maps of calcium phosphate;

FIG. 7(c) shows the SEM image and elemental maps of resultant sludge;

FIG. 8 shows mineralogical composition of CaO nanopowder (hydrated lime), calcium phosphate, and resultant sludge ascertained using X-ray Diffraction (XRD) technique;

FIG. 9 shows the FTIR spectrum of CaO nanopowder (hydrated lime), calcium phosphate, and resultant sludge and their identified functional groups.

### DETAILED DESCRIPTION OF THE PREFFERED EMBODIMENTS

The invention will now be described with reference to the following experimental procedure, and results.

### 2 Materials and Methods

### 2.1 Acquisition of Experimental Samples

Real wastewater effluents which is rich in phosphate and ammonia was collected from a municipal wastewater treatment facility in Tshwane Metropolitan Municipality, Pretoria, South Africa. The treatment facility receives close to 65 megaliters of wastewater from a number of activities from the surrounding area. Similarly, real AMD was collected from a coal mine in Mpumalanga province, South Africa. Researchers ensured that a highly concentrated solution with high acidity and elevated levels of chemical species was collected in a toe seep stockpiling coal facility. High-density polyethylene (HDPE) wide-mouth bottles were used for sample collection (both MWW and AMD). To ensure good purity of the collected samples, the suspended solids and debris were removed by filtration using Macherey-Nagel filter papers (MN 615. ∅125 mm), and the samples were immediately after collection. Thenceforth, real wastewater streams used in this study were authentic and no any form of pre-treatment was done to fortify the concentrations of the samples. Hydrated lime was procured from Protea Chemicals, (Pty) Ltd. The lime sample was received in 25 kg fabric bags and every precaution was taken for storage and utilisation.

### 2.2 Calcium Phosphate Synthesis

The optimal hydrated lime dosage and contact time conditions for calcium phosphate synthesis from municipal wastewater have been reported by Weaver and Ritchie (1994) and

Dunets and Zheng (2014). These conditions were adopted here as emphasized in our previous study (Masindi and Foteinis, 2021). Specifically, the solid (hydrated lime) to liquid (wastewater) (S:L) ratio was kept in the range of 1 g:100 mL, while the contact time (i.e., mixing duration) was 60 min (Masindi and Foteinis, 2021). Lower ratios will lead to a lower recovery of phosphate (P), while ratios higher than will 0.01 g L⁻¹ will not significantly improve P recovery. After treatment, the wastewater/hydrated-lime mixture was allowed to settle for 30 min to ensure that the crystallised sludge was fully settled. The supernatant was then moved to another beaker, pending further treatment depending on the desired use, while the sludge was collected and oven dried (at 105° C. for 24 hours). Finally, the dry sludge was milled into fine powder, by means of ball miller, and sieved using a 100 μm perforated sieve to obtain the desired particle sizes.

### 2.3 Optimisation Studies

To attain an in-depth understanding of factors that influence the removal of contaminants from real AMD, a number of operational parameters were evaluated. These factors were explored by varying a parameter of interest and fixing the rest of the parameters as denoted in Table 1. These include: i) the effect of mixing time (i.e. mixing duration of real AMD with calcium phosphate); ii) the effect of calcium phosphate dosage (i.e. the amount of mechano-thermo activated calcium phosphate used for the treatment of real AMD); and iii) ambient temperature and supernatant pH were considered for optimisation studies. Specifically, the experiments were performed in triplicate using the 1000 mL volumetric flasks and they were stirred at 500 rpm using an overhead stirrer, Model Number: SH-II-7C, Name: digital LCD display Overhead Stirrer used for laboratory, Model: SH-II-7C, voltage: 220V, Speed: 100-2500 rpm, Max mixing volume: 40L, and Plate size: 200*300 mm, USA. To gain in-depth insight onto influential parameters, the one-factor-at-a-time (OFAAT) method was used, i.e. each time one parameter was varied while the others were fixed, as shown in Table 1.

TABLE 1
Parameters evaluated for the treatment of real
AMD using the synthesized calcium phosphate.

| | | | | | pH and | | Mixing |
|---|---|---|---|---|---|---|---|
| Entry | Time | | Dosage | | Temperature | Volume | speed |
| Units | minutes | | grams | | pH unit and ° C. | L | rpm |
| 1 | 5 | mins. | 10 | g | Ambient conditions | 1 L | 300 rpm |
| 2 | 10 | mins | 10 | g | Ambient conditions | 1 L | 300 rpm |
| 3 | 15 | mins | 10 | g | Ambient conditions | 1 L | 300 rpm |
| 4 | 30 | mins | 10 | g | Ambient conditions | 1 L | 300 rpm |
| 5 | 45 | mins | 10 | g | Ambient conditions | 1 L | 300 rpm |
| 6 | 60 | mins | 10 | g | Ambient conditions | 1 L | 300 rpm |
| 7 | 90 | mins | 10 | g | Ambient conditions | 1 L | 300 rpm |
| 8 | 180 | mins | 10 | g | Ambient conditions | 1 L | 300 rpm |
| 9 | 45 | mins | 0.5 | g | Ambient conditions | 1 L | 300 rpm |
| 10 | 45 | mins | 1 | g | Ambient conditions | 1 L | 300 rpm |
| 11 | 45 | mins | 2.5 | g | Ambient conditions | 1 L | 300 rpm |
| 12 | 45 | mins | 5 | g | Ambient conditions | 1 L | 300 rpm |
| 13 | 45 | mins | 10 | g | Ambient conditions | 1 L | 300 rpm |
| 14 | 45 | mins | 15 | g | Ambient conditions | 1 L | 300 rpm |
| 15 | 45 | mins | 25 | g | Ambient conditions | 1 L | 300 rpm |

The effect of different operational parameters were evaluated using the aforementioned experimental conditions, In particular, the evaluated factors were varied whilst the other factors were fixed to precisely determine the effect of the parameter understudy (Kindly refer to Table 1). Thenceforth, as part of quality control, the analytical balance was used to calculate feed dosages but the 2-decimal places were used as the precise dosage. Ambient conditions for the temperature and pH were considered for all the experiments. This was primarily underpinned to the fact that real site conditions will require minimal human interface and cheap cost for technology placement. All experiments were conducted in triplicate and the results were reported as mean values.

### 2.4 Assessing the Percentage Removal of Contaminants

The amount of contaminants removed from real AMD was calculated using the following equation (1):

$$Precentage ( \% ) of contaminants removal = ( \frac{{C}_{0} - {C}_{e}}{{C}_{0}} ) \times 100 \qquad ( 1 )$$

Where, C₀ is the initial concentration of any defined contaminant and Cₑ is the final concentration of any contaminant after treatment.

### 2.5 Characterisation of the Samples

To pinpoint the fate of chemical species before and after the interaction of raw and final feedstock, different analytical techniques were used for the characterisation of liquid and solid samples which were generated from our laboratory experiments. The state-of-art analytical equipments, instruments, and methods were used in accredited laboratories, such as the ISO/IEC 17025:2017 accredited laboratory, at Magalies Water Services Laboratory, Brits, North West, South Africa.

### 2.5.1 Characterisation of Solid Matrices

To ascertain the mineralogical and elemental characteristic of feed and product minerals, X-ray Diffraction (XRD) and X-ray fluorescence (XRF) were used, respectively. Specifically, the PANalytical X'Pert PRO-diffractometer equipped with Philips PW 1710 Diffractometer with graphite secondary monochromatic source and the Thermo Fisher ARL Perform'X Sequential XRF instrument with Uniquant software was used for analyses. The metals-and-anions-functional groups were ascertained using the Fourier Transform Infrared Spectrometer (FTIR), Perkin-Elmer Spectrum 100 Fourier Transform Infrared Spectrometer (FTIR) coupled to the Perkin-Elmer Precisely Universal Attenuated Total Reflectance (ATR) sampling accessory with a diamond crystal. The morphological, Mapping properties, and elemental properties were ascertained using the High Resolution (HR)-Field Emission-Scanning Electron Microscope (FE-SEM) coupled with the Focused-Ion Beam (FIB) and an Energy Dispersive X-ray Spectroscopy (EDX). This enabled us to acquire supreme quality and fine images with trivial distortions. The aforementioned were the analytical techniques which were utilised to give in-depth insights and point out the fate of inorganic contaminants post the treatment of AMD with calcium phosphate synthesized from real municipal wastewater.

### 2.5.2 Characterisation of Aqueous Samples

In-situ properties such as the pH, Electrical conductivity (EC) and Total Dissolved Solids (TDS) were ascertained using the latest multi-parameter probe (HANNA instrument, HI9828). Chemical species concentrations were determined by means of Inductively coupled plasma mass spectrometry (ICP-MS), XSeries 2, ICP-MS, supplied by Thermo scientific, from Hanna-Kunath-Str. 11 28199 Bremen, Germany. The ICP-MS was coupled to ASX-520 Auto sampler. Inductively coupled plasma-optical emission spectrometry (ICP-OES), 5110 ICP-OES vertical dual view, Agilent technologies Australia, Made in Malaysia. The ICP-OES was coupled with Agilent SPS 4 Auto sampler. Gallery plus photo spectrometer, Automated chemistry analyser, Supplied by Thermo Fisher scientific, Made in Vantaa, Finland. The listed equipments were utilised inter-changeably depending on availability and characterisation needs. National Institute of Standards and Technology (NIST) standards reference materials and quality control procedures were duly considered during the experiments and on analyses.

### 2.7 Verification of Mineral Phases Using Geochemical Modelling

To substantiate experimental results and determine aqueous species and mineral phases that are more likely to precipitate from hydrated lime (lime nanopowder)-MWW and calcium phosphate-AMD interactions, geochemical modelling was applied. The primary aim was to determine speciation and calculate the saturation indices (SIs) of the mineral phases, based on compositions of feed waters and then predict product water. To precisely accomplish that objective, the PH REdox EQuilibrium (in C language) (PHREEQC) geochemical model using the WATEQ4F chemical speciation model were used (Masindi et al., 2018c, Masindi et al., 2022). Furthermore, the chemical species which were more likely to precipitate were determined using the modelled SI index whereby, SI values lower than unity (<-1) denote an under saturated solution, SI values equal to unity (=1) denote a saturated solution and, lastly, SI values higher than unity (>1) denote a supersaturated solution. Results from simulation was also used to underpin some of the technical findings from analytical instruments such as SEM-EDS, XRD, and ICP-MS.

### 3 Results and Discussions

This section is going to focus on the findings for the synthesis of struvite from real municipal wastewater (section 3.1) and its application for the treatment of real mine water (section 3.2). Results from different analytical techniques will duly be unpacked and explicitly be discussed while PHREEQC geochemical model will be used to substantiate experimental results. Quality control procedures were duly considered in all the experiments as alluded in the materials and methods section.

### 3.1 The Synthesis of Calcium Phosphate

The chemical composition of raw water and final water containing contaminant metal species during the synthesis of calcium phosphate from municipal wastewater is shown in Table 2.

TABLE 2
The chemical composition of raw and final water during the
synthesis of calcium phosphate from municipal wastewater.

| Parameter | Units | Before treatment | After treatment |
|---|---|---|---|
| Ph | — | 7.8 | 11.5 |
| Ammonia | Ppm | 180 | 20 |
| Phosphate | Ppm | 120 | 0.1 |
| Ca | Ppm | 27 | 1351 |
| Mg | Ppm | 50 | 0.05 |

As shown in Table 2, the levels of ammonia, phosphate, calcium, magnesium and pH were reported. Calcium phosphate was synthesized at optimised conditions using hydrated lime as emphasized in our previous study (Masindi and Foteinis, 2021). The mineral was synthesized for 60 minutes, at 250 rpm using a jar stirrer, and 5 g in 1 L (w/v ratios). The obtained results revealed 99.9% removal for phosphate, and 88% removal for ammonia. Ammonia could have been removed as through stripping following Le Chatelier's principle of equilibrium whilst phosphate has been adsorbed onto Ca part of lime to form calcium phosphate as denoted below. The obtained results were also confirmed by PHREEQC geochemical modelling. The synthesized calcium phosphate was then utilised for the treatment of real acid mine drainage from coal mining facility.

### 3.2 Optimisation Studies

To evaluate the effect of contact time and calcium phosphate dosage, the time and dosages were varied at specified intervals as shown in Table 1 and the results are reported in this section (3.2.1 and 3.2.2).

### 3.2.1 Effect of Contact Time

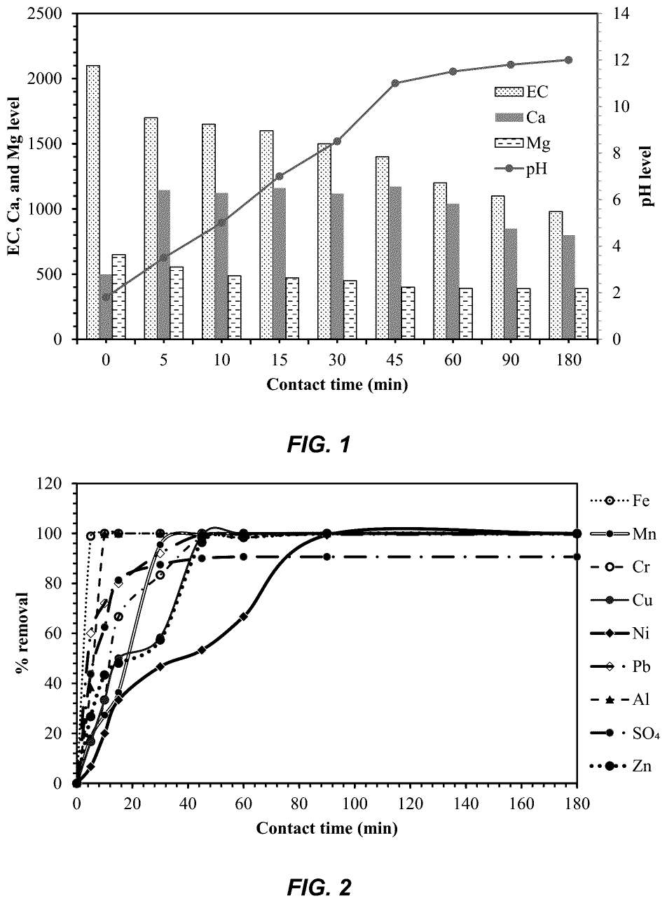

Variation in EC (mS/cm), pH, Ca (mg/L), and Mg (mg/L) with an increase in contact time during the treatment of real AMD using the synthesized calcium phosphate is shown in FIG. 1.

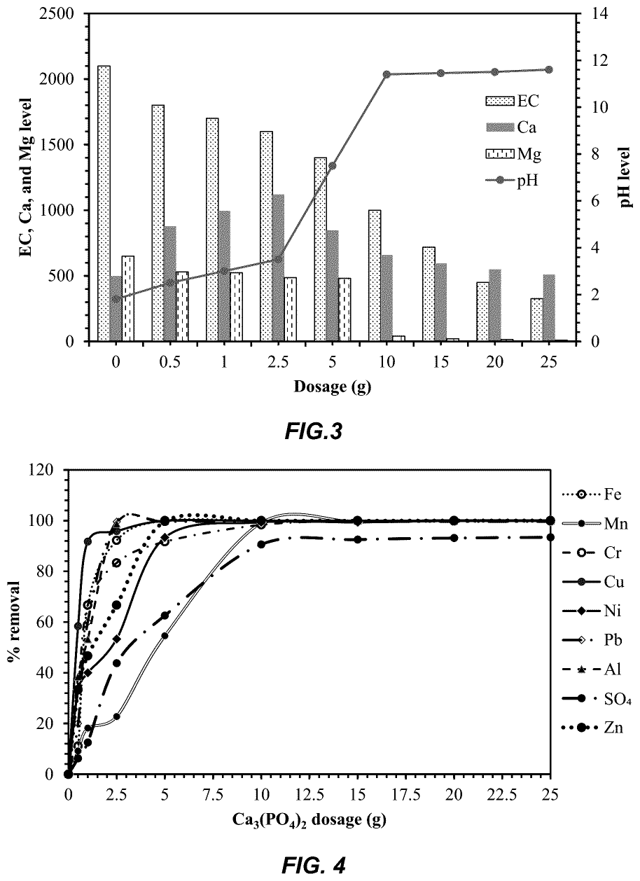

The effect of contact time, i.e. mixing duration, on the attenuation of EC was examined by considering a wide spectrum of mixing durations, i.e. 0, 5, 10, 30, 45 and 60 mins. (Table 1). As shown in FIG. 1, there was a decrease in EC was observed from 0 to 180 min. A decrease in EC denotes the removal of ions from aqueous solution. This could be linked to the removal of Ca and phosphate from aqueous solution. Furthermore, the supernatant pH was observed to increase with an increase in contact time, however, it was observed to approach stability after 45 minutes of mixing. An inverse relationship was observed between Ca and Mg, whereby Ca increase from 1-45 mins and then commenced to decrease (60-180 mins.). An increase in Ca denotes dissolution whilst a decrease in Ca²⁺ denotes the possibility of calcium phosphate formation as predicted by PHREEQC. On the other hand, the level of Mg²⁺ was observed to increase with an increase in contact time and this could be explained by a possible dissolution of struvite. This has also been predicted by PHREEQC where Mg²⁺ and Ca²⁺ existed as divalent species in aqueous solution. An increase in Mg level will proportionally increase the pH of the system due to the addition of hydroxyl groups into the system. Similar results were reported in Masindi et al. (2018a). The variation in percentage removal of chemical species with an increase in contact time is shown in FIG. 2.

FIG. 2 shows that there was a general increase in the percentage removal of different contaminants during the interaction of AMD with calcium phosphate. The removal of contaminants was observed to be dependent on time. A steep increase in the % removal of contaminants but this was aligned to different chemical species and their precipitation pH as reported by Masindi et al. (2018b). Furthermore, the level of sulphate was observed to be inversely proportional to the Ca concentration and this may be attributed to chemical adsorption. This further confirms the potential for gypsum formation as predicted by PHREEQC geochemical model and XRD technique. According to FIG. 2, high removal efficacies (>99.5%) were observed at 45 minutes for Fe, Al, Mn, Cr, Cu, Ni, and Zn. This could be attributed to an increase in pH with an increase in time. The removal efficacy for sulphate was also observed to gradually increase with an increase in time. As such, ≈90 minutes was taken as the optimum time for the removal of different contaminants from real AMD and this will be utilized in our subsequent experiments.

### 3.2.2 Effect of Calcium Phosphate Dosage

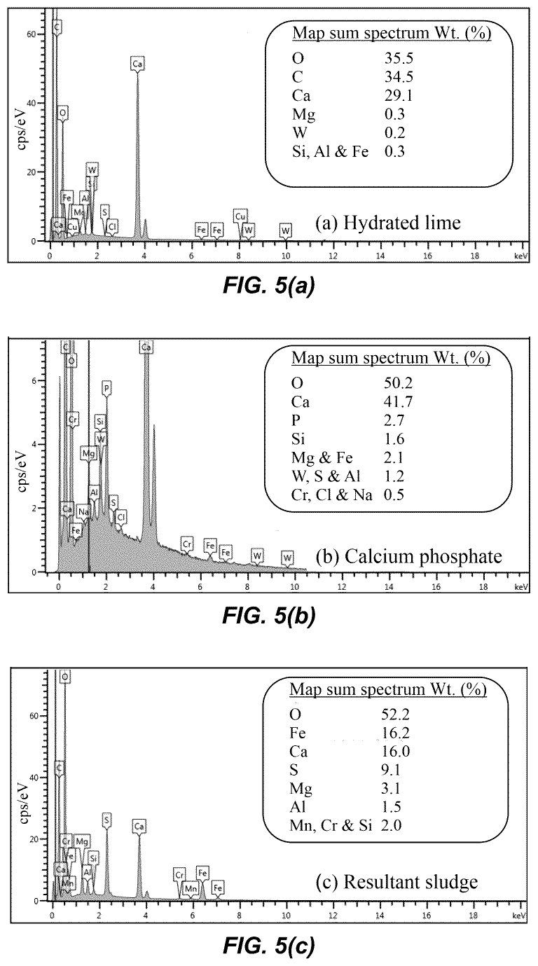

Variation in EC (mS/cm), pH, Ca (mg/L), and Mg (mg/L) with an increase in calcium phosphate dosage during the treatment of real AMD using the synthesized calcium phosphate is shown in FIG. 3. The effect of feed dosage on the reduction of EC was examined by varying the dosages of calcium phosphate as stipulated in Table 1.

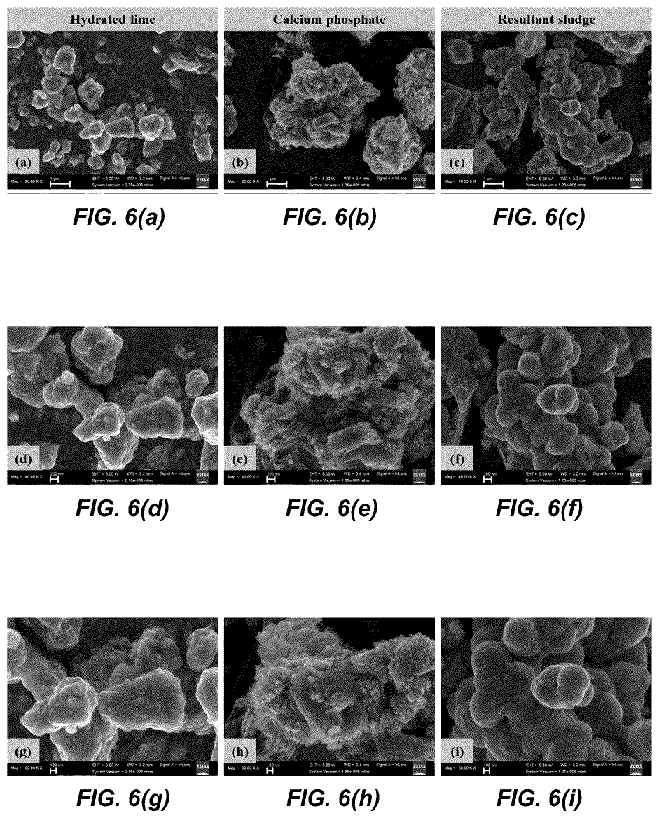

As shown in FIG. 3, the EC was observed to decrease with an increase in calcium phosphate dosage. A decrease in EC could be attributed to the reduction of Ca and S during the formation of gypsum during the interaction. Thenceforth, the precipitation of metals as hydroxides as predicted by PHREEQC could be accounting for the reduction in EC. Similarly, the pH of the solution was observed to increase with an increase in feedstock dosage and this could be attributed to an increase in alkalinity of the system. From 0-2.5, there was an increase in EC, thereafter, there was an increase in Ca from 5-25 g and this may be attributed to the reduction in the level of Ca due to the formation of gypsum from sulphate embodied in real AMD as predicted by PHREEQC geochemical model. The levels of Ca²⁺ were observed to drastically increase with an increase in calcium phosphate dosage, and this could be explained by the dissolution of calcium phosphate in AMD leading to an increase in Ca²⁺ concentration. This was also predicted by PHREEQC. In light of the obtained results, 10 g/L of calcium phosphate is adequate for the treatment of AMD. The variation in the percentage removal of chemical species with an increase in struvite dosage during the treatment of real AMD with struvite is shown in FIG. 4.

FIG. 4 shows that there was an increase in the % removal of different contaminants during the interaction of AMD with calcium phosphate as a function of dosage. A steep increase in the % removal of contaminants from the real AMD but this was aligned to pH. Furthermore, the level of sulphate was observed to be directly proportional to Ca²⁺ concentration whereby the Ca was reducing with an increase in calcium phosphate concentration. This has resulted to an increase in gypsum formation as predicted by PHREEQC geochemical modelling and XRD including HR-SEM-EDS mapping. The presence of Ca in matrices of calcium phosphate will reacts with AMD water to release hydroxyl ions (OH⁻) which then contribute to an increase in pH. An increase in pH was also predicted by PHREEQC geochemical model. Furthermore, 10 g was adequate for the removal of chemical species from aqueous solution. The removal of chemical species were observed to follow the following sequence: Fe at pH≥3 - 3.5, calcium sulphate from pH≥4 -9, Al at pH≥4-6.5, Mn at pH≥8-9.5, Cu at pH≥6-7, Zn at pH≥6-8, Pb at pH≥6.5-8-8 and Ni at pH≥9.5. Similarly, PHREEQC geochemical model corroborated this findings. As such, 10 g was taken as the optimum dosage for the removal of different contaminants from AMD and it will then be used for the treatment of AMD for our subsequent experiments.

### 3.3 Treatment of AMD at Optimised Conditions

The physico-chemical properties of AMD before and after interacting with the synthesized calcium phosphate at optimised conditions are reported in Table 3.

TABLE 3
The physico-chemical properties of AMD before and after interacting
with the synthesized calcium phosphate at optimised conditions.

| Parameter | Units | Before treatment | After treatment |
|---|---|---|---|
| pH | — | 1.8 | 11.45 |
| Fe | Ppm | 1800 | 0.02 |
| Al | Ppm | 500 | 0.01 |
| Mn | Ppm | 98 | 0.05 |
| Sulphate | Ppm | 11986 | 1128 |
| Ca | Ppm | 622 | 659 |
| Mg | Ppm | 495 | 0.34 |

As shown in Table 3, there was an effective removal of pollutants from AMD using calcium phosphate at optimised conditions. Specifically, contaminants of concern were removed from feed water and this is evident in product water. The pH was observed to increase from 1.8 to 11.45 hence indicating that there is a reaction which was taking place that led to an increase in pH. Alkalinity of the resultant water was observed to have increase after contacting the synthesized calcium phosphate hence indicating an enrichment of waterbodies by calcium. The presence of elevated levels of Fe and sulphate denotes that the genesis of this AMD is as a result of weathering of pyrite (FeS) (Tabelin et al., 2017a, b). Moreover, Al, Fe, Mn and sulphate were observed to be the most predominant elements. This corroborates results reported by other researchers (Maree et al., 1996, Maree et al., 2004, Park et al., 2019). Notable levels of Ca and Mg were also observed to be present in AMD interface. PHREEQC geochemical model predicted these chemical to exist as divalent, trivalent and oxyanions in AMD and product water. However, after the interaction of AMD with calcium phosphate, major chemicals such as Al, Fe and Mn were effectively removed from the AMD interface to the product sludge. Similar findings were reported using PHREEQC geochemical model. The level of pH, were observed to have increased after the treatment of AMD with calcium phosphate. Metals removal efficiency was ≥99.5% for metals and ≥90% for sulphate. Moreover, the Ca and Mg levels were a bit high and they were also observed to have reduced after the chemical reaction. Thenceforth, the system managed to remove 90% of sulphate from AMD as reported in product water and this could be a game changer. This could be linked to the level of Ca and its removal efficacy since gypsum in the main route of sulphate attenuation during the treatment of AMD. In light of the obtained results, polishing of product water for drinking purposes might be required to reduce sulphate and Ca levels from the aqueous solution. This could be done using softeners and reverse osmosis (RO) to polish the water to required standards as stipulated in different water quality guidelines, requirements, specifications and standards. Alternatively, just adjusting the pH for discharge purposes would go a long way on conserving the environment and its resources.

### 3.4 Characterisation

This section is going to give insights on the fate of chemical species post the interaction of AMD with the synthesized calcium phosphate. PHREEQC geochemical simulations on the fate of chemical species will be used to further substantiate the fate, forms and complexes that are more likely to be formed from the interaction of the synthesized calcium phosphate and real AMD.

### 3.4.1 Elemental Composition

The elemental composition of hydrated lime, calcium phosphate, and calcium phosphate-AMD sludge are shown in Table 4.

TABLE 4
The elemental composition of hydrated lime, calcium
phosphate, and calcium phosphate-AMD sludge.

| | Standard and | | | | |
|---|---|---|---|---|---|
| | verified data | | Experimental data | | |
| Wt. | BHVO-1 | BHVO-1 | | | Ca₃(PO₄)₂ + |
| % | STD | Analysed | Ca(OH)₂ | Ca₃(PO₄)₂ | AMD |
| SiO₂ | 49.94 | 48.17 | 2.78 | 3.11 | 1.89 |
| Al₂O₃ | 13.8 | 17.33 | 0.60 | 0.64 | 2.21 |
| MgO | 7.23 | 5.96 | 1.09 | 1.68 | 2.22 |
| Na₂O | 2.26 | 2.94 | 0.15 | 0.14 | 0.21 |
| P₂O₅ | 0.273 | 0.31 | 0.09 | 4.41 | 0.35 |
| Fe₂O₃ | 12.23 | 10.98 | 0.29 | 0.35 | 23.82 |
| K₂O | 0.52 | 0.57 | <0.01 | <0.01 | <0.01 |
| CaO | 11.4 | 10.82 | 71.35 | 62.11 | 37.80 |
| TiO₂ | 2.71 | 2.50 | 0.02 | 0.02 | 0.01 |
| V₂O₅ | 0.0566 | 0.06 | <0.01 | <0.01 | <0.01 |
| Cr₂O₃ | 0.0422 | 0.04 | <0.01 | <0.01 | <0.01 |
| MnO | 0.168 | 0.17 | 0.01 | 0.00 | 0.24 |
| NiO | 0.0154 | 0.01 | <0.01 | <0.01 | <0.01 |
| CuO | 0.017 | 0.02 | <0.01 | <0.01 | <0.01 |
| ZrO₂ | 0.0242 | 0.02 | 0.01 | 0.02 | <0.01 |
| SO₃ | — | 0.01 | 1.11 | 1.57 | 24.16 |
| Nb₂O₅ | — | — | <0.01 | 0.01 | <0.01 |
| Co₃O₄ | — | 0.02 | <0.01 | <0.01 | 0.02 |
| ZnO | — | — | <0.01 | <0.01 | 0.02 |
| SrO | — | 0.04 | 0.29 | 0.23 | 0.12 |
| Y₂O₃ | — | — | <0.01 | <0.01 | 0.01 |
| LOI | — | — | 22.17 | 23.95 | 6.89 |
| Total | 100.69 | 99.96 | 99.95 | 98.25 | 99.97 |

As shown in Table 4, hydrated lime (CaO nanopowder) comprised Ca as the major element with traces of Si and Mg. The loss if ignition (LOI) was also observed to be high but this could be attributed to water, volatile compounds, organic matter, and carbonates in the matrices of hydrated lime (CaO nanopowder). The presence of Ca will aid in the removal of phosphate and ammonia from municipal wastewater as calcium phosphate and ammonia as nitrogen gas. After interacting hydrated lime with municipal wastewater, the product sludge was enriched with phosphate (P), Ca, Si, and Mg as shown in the XRF results. The level of S remained the same in raw and product sludge. This could be attributed to the formation of calcium phosphate during the interaction of Ca, P and NH₃. These results could be attested by the reduction in phosphate level from real municipal wastewater. The presence of Si, Mg and P confirms co-precipitation of these chemical species. Findings of this study further confirmed the formation of calcium phosphate. Thenceforth, the resultant sludge, i.e. calcium phosphate, was used for the treatment of AMD. As shown in Table 4, there is elevated levels of Fe, Al, Mn, Mg, and S, which are present in elevated concentration on AMD. Predominant elements were Fe, Ca and S, and traces elements were Al, Si, Mg, and Mn. This is evident enough that the product sludge is acting as a sink of predominant chemical species in AMD. The obtained results corroborates the water quality results. PHREEQC geochemical model confirmed the removal of chemical species as hydroxides, oxy(-hydroxides) and oxy-hydro-sulphates from AMD to product sludge. The presence of Fe, Al, Mn, and SO₄²⁻ in the sludge explicitly corroborates the ICP-MS and Gallery plus water quality results on final water. Interestingly, there was a reduction in Si and Ca hence denoting that these are the elements that are contributing to an increase in pH due to their dissolution as historically reported in literature (Masindi et al., 2017, Masindi et al., 2018c).

### 3.4.2 Elemental Composition as Confirmed by HR-SEM-EDS Detector

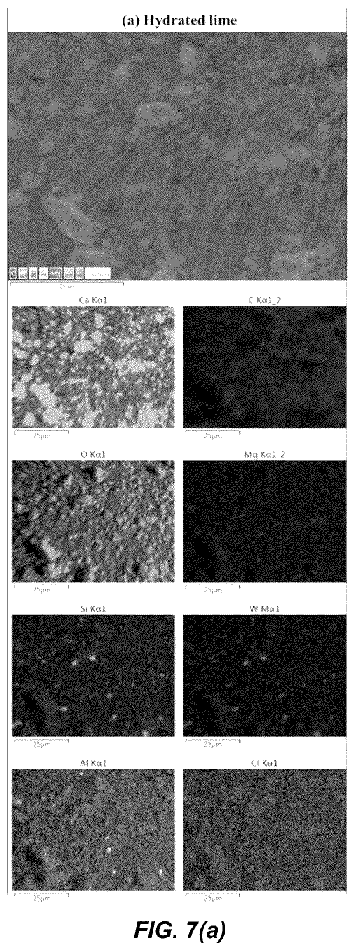

Elemental composition of hydrated lime (CaO nanopowder) (a), calcium phosphate (b), and resultant sludge (c) are shown in FIG. 5(a-c).

In FIG. 5(a) hydrated lime (CaO nanopowder) was characterised of Ca, C and O as major elements. The presence of 0 confirms that they existed as oxides whilst the C denotes its genesis of limestone which prevails after calcination. Elevated levels of Ca denotes the feasibility of phosphate and ammonia removal from real municipal wastewater thus leading to the formation of calcium phosphate as the product mineral. Thenceforth, after interacting CaO nanopowder (hydrated lime) with real municipal wastewater (FIG. 5b) led to the enrichment of product sludge with phosphate as confirmed by the XRF results. This could be attributed to the formation of calcium phosphate during the interaction of Ca and P in real municipal wastewater and interacting CaO nanopowder (hydrated lime). The common elements were observed to be O, Ca, and P in the product mineral, here referred as calcium phosphate. Thenceforth, the results could be linked to the reduction in the levels of phosphate in real municipal wastewater. Traces of other impurities were observed but these could be attributed to other chemicals that were embodied in real municipal wastewater matrices. Furthermore, the resultant sludge, i.e. calcium phosphate, was used for the treatment of real coal AMD. After interacting the synthesized calcium phosphate and real coal AMD [FIG. 5(c)], the levels of O, Fe, Al, Mn, and SO₄²⁻ were observed to have increased. The principal elements were Fe, O, S, and Ca, and traces of Mg, Al, Mn, Cr, and Si. This is evident enough that the product sludge is acting as a sink of chemical species in real AMD. The obtained results corroborates the water quality results. These results are also consistent to what has been reported in XRF. These results are precisely congruent to what has been explicitly reported by PHREEQC geochemical model simulations, Water Q-4 database.

### 3.4.3 Morphological Properties

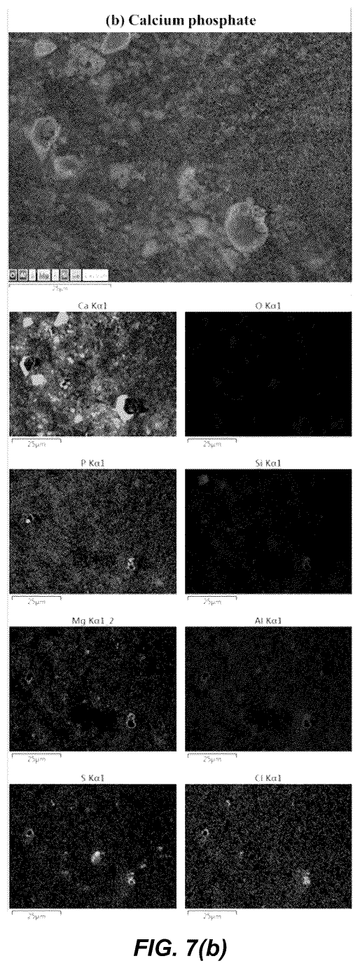

The morphological properties of CaO nanopowder (hydrated lime), synthesized calcium phosphate, and AMD-reacted calcium phosphate (product sludge) are shown in FIG. 6-(a-i). To attain high quality imagery with no distortion, the high-resolution Focused Ion Beam Scanning Electron Microscope (HR-FIB FESEM) instrument was used to point-out morphological characteristics of the materials. In particular, the Auriga Cobra HR-FIB FESEM was used for the purpose of this study. The use of high-resolution Focused Ion Beam Scanning Electron Microscope ensured the acquisition of clear, high resolution, and stable imageries hence meticulously aiding in the acquisition of finely clear picture that explicitly denotes the microstructural properties of the acquired images.

Microstructural properties of CaO nanopowder, synthesized calcium phosphate, and AMD-reacted calcium phosphate (product sludge) are shown in FIG. 6(a-i). FIG. 6(a, d, and g), shows CaO nanopowders (hydrated lime). The morphological characteristics were observed to be the same in different magnifications. Specifically, CaO nanopowders comprised rectangular scales lumped together. Moreover, calcium phosphate denoted rod-like structures lumped together. The microstructural properties were the same in different magnifications, i.e. 1 μm, 200 nm and 100 nm [FIG. 6(b, e, and h)]. Finally, the product sludge after the interaction of calcium phosphate and real acid mine drainage comprised spherical particles connected to each other on a dendritic fashion [FIG. 6(c, f, and i)]. The microstructural properties were the same in all the magnifications.

### 3.4.4 Elemental Mapping Using EDS Capabilities

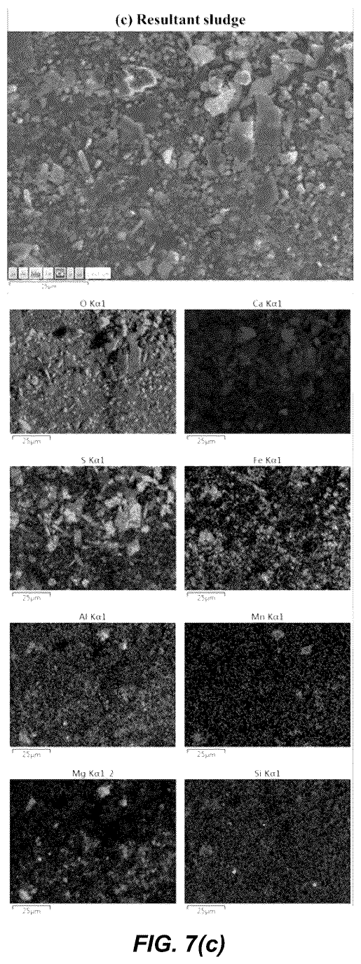

To further corroborate and expatiate the elemental composition of CaO nanopowder (hydrated lime), synthesized calcium phosphate, and AMD-reacted calcium phosphate (product sludge) at microstructural sphere, elemental mapping using Auriga Cobra FIB-FESEM instrument coupled to the EDS detector was utilized. The elemental mapping of CaO nanopowder (hydrated lime), synthesized calcium phosphate, and AMD-reacted calcium phosphate (product sludge) are shown in FIG. 7(a-c).

FIG. 7(a) shows CaO nanopowder (hydrated lime) comprising Ca, O, and C as dominant elements. Fair dispersion of other elements such as Mg, Si, W, Al and Cl were observed. The presence of Ca, O, and C as predominant elements confirms that the material being used for the synthesis of calcium phosphate is CaO nanopowders of carbonate origin. The obtained results confirms what has been reported by EDS spectrum and XRF techniques. Furthermore, FIG. 7(b) shows an elemental map of calcium phosphate predominated of Ca, O, and P as dominant elements amongst dispersed traces of Mg, Al, Si, S, and Cl. The presence of Ca, O and P denotes the formation of hydrated calcium phosphate as confirmed by the PHREEQC geochemical model.

Finally, the product sludge after the treatment of acid mine drainage comprised O, Ca, S and Fe as predominant elements which were evenly distributed across the surface [FIG. 7(c)]. Traces of other elements such as Mn, Al, Mg and Si were also present. The presence of Ca, O, and S confirms the formation of gypsum whilst the presence of Fe and O confirms the formation of Fe-hydroxides. Furthermore, PHREEQC predicted the possible formation of oxy-(hydro)-sulphates. The obtained results corresponds to ICP-MS results.

### 3.4.5 Mineralogical Merties

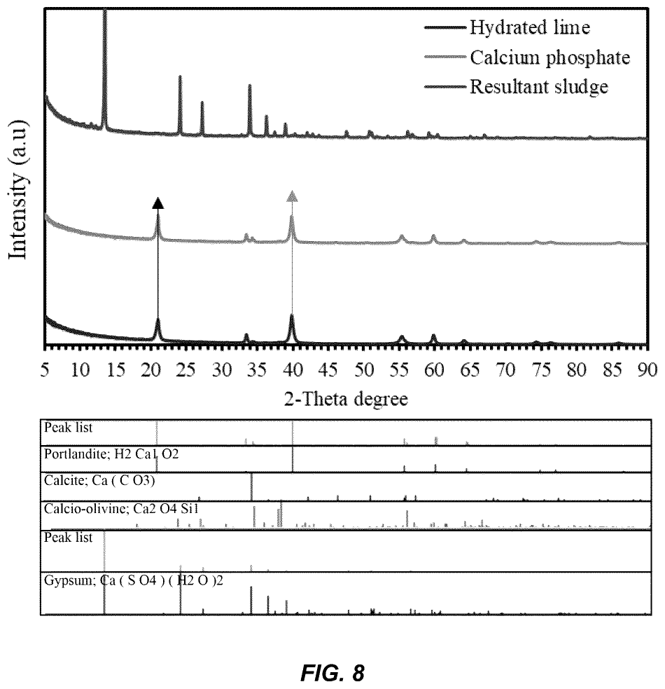

The mineralogical composition of CaO nanopowder (hydrated lime), calcium phosphate, and resultant sludge were ascertained using X-ray Diffraction (XRD) technique and the results are shown in FIG. 8.

In FIG. 8 shows the crystal phases of CaO nanopowder (hydrated lime), calcium phosphate, and resultant sludge. Specifically, CaO nanopowder (hydrated lime) comprised portlandite, calcite, and calico-olivine. The obtained results justifies elevated levels of Ca, O, and Si in the raw mineral as confirmed by XRF and EDS. However, calcium phosphate was predominated by portlandite as the hydrated form of calcium. This is the crystalline phase hence denoting that other elements which were detected using XRF and SEM-EDS are amorphous in nature. However, after contacting calcium phosphate with AMD, new mineral phases were observed and they mainly comprise gypsum. The noisy spectrogram denotes the presence of amorphous phases in the product sludge.

### 3.4.6 Functional Groups

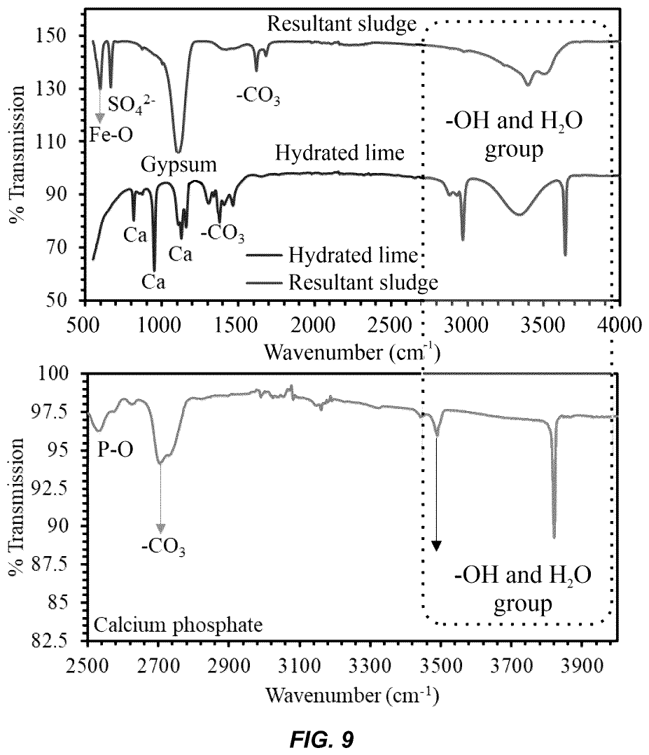

The FTIR spectrum of CaO nanopowder (hydrated lime), calcium phosphate, and resultant sludge and their identified functional groups in-line with their wavenumber (cm⁻¹) are shown in FIG. 9.

FIG. 9 shows the functional groups of CaO nanopowder (hydrated lime) comprising the carbonates duplex (1500), hydroxyl groups from water (3000 and 3700 cm⁻¹), and Ca (800, 1000, and 1200 cm⁻¹). These elements will play an indispensable role in the removal of phosphate as calcium phosphate. The obtained FTIR results corroborates XRD and XRF findings. Furthermore, the availability of water (—OH) in CaO nanopowders confirm that the material is hydrated hence the name hydrated lime. Furthermore, the interaction of hydrated lime and municipal wastewater lead to a mineral that has P—O (2600 cm⁻¹), CO₃ (2700 cm⁻¹), and OH⁻ (3800 cm⁻¹) hence confirming the formation of a phosphate-based mineral. Finally, the product mineral after the interaction of calcium phosphate and AMD lead to the product sludge that comprise Fe—O (550 cm⁻¹), SO₄ (700 cm⁻¹), gypsum (1200 cm⁻¹), CO3 (1600 cm⁻¹), and OH⁻ (3600 cm⁻¹). The presence of Fe and OH groups denotes the formation of Fe-hydroxide whilst the presence of gypsum confirms the sink of SO4 from AMD into the product sludge.

### CONCLUSION

The synthesis of calcium phosphate from real municipal wastewater and its novel application for the treatment of real acid mine drainage from a coal mine was successfully explored. Effective operational conditions were observed to be 10 g of dosage in 1L of real AMD and 90 minutes of equilibration. The Ca₃(PO₄)₂ achieved ≥99.5% for metals (Al⁺, Fe³⁺, and Mn²⁺) and ≥90% for SO₄²⁻ from real AMD including significant amount of Zn, Cu, Ni, Pb, and Cr. Geochemical simulations confirmed that chemical species existed as divalent, trivalent and oxyanions in aqueous solution. Furthermore, minerals were removed as oxy-(hydro)-sulphates, oxy-(hydro)-phosphate, metals hydroxides, and other complexes. Findings from laboratory assays, analytical techniques and simulations corroborated each other hence confirming the effectiveness of the synthesis Ca₃(PO₄)₂. PHREEQC geochemical model suggested that the chemical species were removed as (oxy)-hydroxides, (oxy)-hydro-sulphates, and metals hydroxides. Ca and SO₄²⁻ were removed as gypsum (CaSO₄.2H₂O) and Pb, Fe, and Al as hydroxyl sulphate minerals and this was in-line to the FTIR, XRD, and EDS results. Findings from this study demonstrated the feasibility of beneficiating real municipal wastewater for the synthesis of calcium phosphate and its novel valorisation for the treatment of real coal AMD. The developed technology could play a huge role in minimizing the ecological footprints of acid mine drainage (AMD) and municipal wastewater. In light of the above, future research should focus on the use of life cycle assessment tools to measure ecological footprints of this initiative and sequential recovery of valuable minerals from AMD.

### REFERENCES

Akinwekomi, V., Maree, J. P., Masindi, V., Zvinowanda, C., Osman, M. S., Foteinis, S., Mpenyana-Monyatsi, L. & Chatzisymeon, E. 2020. Beneficiation of acid mine drainage (AMD): A viable option for the synthesis of goethite, hematite, magnetite, and gypsum—Gearing towards a circular economy concept. Minerals Engineering, 148, 106204.
Amann, A., Zoboli, 0., Krampe, J., Rechberger, H., Zessner, M. & Egle, L. 2018. Environmental impacts of phosphorus recovery from municipal wastewater. vResources, Conservation and Recycling, 130, 127-139.
Ansari, A. J., Hai, F. I., Price, W. E., Drewes, J. E. & Nghiem, L. D. 2017. Forward osmosis as a platform for resource recovery from municipal wastewater—A critical assessment of the literature. Journal of Membrane Science, 529, 195-206.
Arola, K., Manttari, M. & Kallioinen, M. 2021. Two-stage nanofiltration for purification of membrane bioreactor treated municipal wastewater—Minimization of concentrate volume and simultaneous recovery of phosphorus. Separation and Purification Technology, 256, 117255.
Arola, K., Van Der Bruggen, B., Manttari, M. & Kallioinen, M. 2019. Treatment options for nanofiltration and reverse osmosis concentrates from municipal wastewater treatment: A review. Critical Reviews in Environmental Science and Technology, 49, 2049-2116.
Baker, B. J. & Banfield, J. F. 2003. Microbial communities in acid mine drainage. FEMS Microbiology Ecology, 44, 139-152.
Bouwer, H. 2000. Integrated water management: emerging issues and challenges. Agricultural Water Management, 45, 217-228.
Dunets, C. S. & Zheng, Y. 2014. Removal of phosphate from greenhouse wastewater using hydrated lime. Environmental Technology, 35, 2852-2862.
Ghabris, A. H., Abdel-Jawad, M. & Aly, G. S. 1989. Municipal wastewater renovation by reverse osmosis state of the art. Desalination, 75, 213-240.
Kefeni, K. K., Msagati, T. a. M. & Mamba, B. B. 2017. Acid mine drainage: Prevention, treatment options, and resource recovery: A review. Journal of Cleaner Production, 151, 475-493.
Maree, J. P., Hlabela, P., Nengovhela, R., Geldenhuys, A. J., Mbhele, N., Nevhulaudzi, T. & Waanders, F. B. 2004. Treatment of mine water for sulphate and metal removal using barium sulphide. Mine Water and the Environment, 23, 195-203.
Maree, J. P., Van Tonder, G. J., Millard, P. & Erasmus, T. C. 1996. Pilot-scale neutralisation of underground mine water. Water Science and Technology.
Masindi, V. & Foteinis, S. 2021. Recovery of phosphate from real municipal wastewater and its application for the production of phosphoric acid. Journal of Environmental Chemical Engineering, 9, 106625.
Masindi, V., Foteinis, S. & Chatzisymeon, E. 2022. Co-treatment of acid mine drainage and municipal wastewater effluents: Emphasis on the fate and partitioning of chemical contaminants. Journal of Hazardous Materials, 421, 126677.
Masindi, V., Gitari, M. W., Tutu, H. & Debeer, M. 2017. Synthesis of cryptocrystalline magnesite— bentonite clay composite and its application for neutralization and attenuation of inorganic contaminants in acidic and metalliferous mine drainage. Journal of Water Process Engineering, 15, 2-17.
Masindi, V., Madzivire, G. & Tekere, M. 2018a. Reclamation of water and the synthesis of gypsum and limestone from acid mine drainage treatment process using a combination of pre-treated magnesite nanosheets, lime, and CO2 bubbling. Water Resources and Industry, 20, 1-14.
Masindi, V., Ndiritu, J. G. & Maree, J. P. 2018b. Fractional and step-wise recovery of chemical species from acid mine drainage using calcined cryptocrystalline magnesite nano-sheets: An experimental and geochemical modelling approach. Journal of Environmental Chemical Engineering, 6, 1634-1650.
Masindi, V., Osman, M. S., Mbhele, R. N. & Rikhotso, R. 2018c. Fate of pollutants post treatment of acid mine drainage with basic oxygen furnace slag: Validation of experimental results with a geochemical model. Journal of Cleaner Production, 172, 2899-2909.
Masindi, V., Osman, M. S. & Shingwenyana, R. 2019. Valorization of acid mine drainage (AMD): A simplified approach to reclaim drinking water and synthesize valuable minerals—Pilot study. Journal of Environmental Chemical Engineering, 7, 103082.
Mavhungu, A., Foteinis, S., Mbaya, R., Masindi, V., Kortidis, I., Mpenyana-Monyatsi, L. & Chatzisymeon, E. 2020a. Environmental sustainability of municipal wastewater treatment through struvite precipitation: Influence of operational parameters. Journal of Cleaner Production, 124856.
Mavhungu, A., Masindi, V., Foteinis, S., Mbaya, R., Tekere, M., Kortidis, I. & Chatzisymeon, E.
   2020b. Advocating circular economy in wastewater treatment: Struvite formation and drinking water reclamation from real municipal effluents. Journal of Environmental Chemical Engineering, 8, 103957.
Mavhungu, A., Mbaya, R., Masindi, V., Foteinis, S., Muedi, K. L., Kortidis, I. & Chatzisymeon, E. 2019. Wastewater treatment valorisation by simultaneously removing and recovering phosphate and ammonia from municipal effluents using a mechano-thermo activated magnesite technology. Journal of Environmental Management, 250, 109493.
Naidu, G., Ryu, S., Thiruvenkatachari, R., Choi, Y., Jeong, S. & Vigneswaran, S. 2019. A critical review on remediation, reuse, and resource recovery from acid mine drainage. Environmental Pollution, 247, 1110-1124.
Neculita, C. M. & Rosa, E. 2019. A review of the implications and challenges of manganese removal from mine drainage. Chemosphere, 214, 491-510.
Park, I., Tabelin, C. B., Jeon, S., Li, X., Seno, K., Ito, M. & Hiroyoshi, N. 2019. A review of recent strategies for acid mine drainage prevention and mine tailings recycling. Chemosphere, 219, 588-606.
Petrie, B., Barden, R. & Kasprzyk-Hordern, B. 2015. A review on emerging contaminants in wastewaters and the environment: Current knowledge, understudied areas and recommendations for future monitoring. Water Research, 72, 3-27.
Rosemarin, A., Macura, B., Carolus, J., Barquet, K., Ek, F., Jarnberg, L., Lorick, D., Johannesdottir, S., Pedersen, S. M., Koskiaho, J., Haddaway, N. R. & Okruszko, T. 2020. Circular nutrient solutions for agriculture and wastewater—a review of technologies and practices. Current Opinion in Environmental Sustainability, 45, 78-91.
Sahoo, P. K., Kim, K., Equeenuddin, S. M. & Powell, M. A. 2013. Current approaches for mitigating acid mine drainage. Reviews of environmental contamination and toxicology, 226, 1-32.
Sheoran, V., Sheoran, A. & Choudhary, R. P. 2011. Biogeochemistry of acid mine drainage formation: A review. Mine Drainage and Related Problems, 119-154.
Simate, G. S. & Ndlovu, S. 2014. Acid mine drainage: Challenges and opportunities. Journal of Environmental Chemical Engineering, 2, 1785-1803.
Singh, S., Sukla, L. B. & Goyal, S. K. 2020. Mine waste & circular economy. Materials Today: Proceedings.
Soucek, D. J., Cherry, D. S. & Trent, G. C. 2000. Relative acute toxicity of acid mine drainage water column and sediments to Daphnia magna in the Puckett's Creek watershed, Virginia, USA. Archives of Environmental Contamination and Toxicology, 38, 305-310.
Tabelin, C. B., Veerawattananun, S., Ito, M., Hiroyoshi, N. & Igarashi, T. 2017a. Pyrite oxidation in the presence of hematite and alumina: I. Batch leaching experiments and kinetic modeling calculations. Science of The Total Environment, 580, 687-698.
Tabelin, C. B., Veerawattananun, S., Ito, M., Hiroyoshi, N. & Igarashi, T. 2017b. Pyrite oxidation in the presence of hematite and alumina: II. Effects on the cathodic and anodic half-cell reactions. Science of The Total Environment, 581-582, 126-135.
The United Nations. 2018. The Sustainable Development Goals Report. In: THE UNITED NATIONS & DEPARTMENT OF ECONOMIC AND SOCIAL AFFAIRS. (eds.).
Weaver, D. M. & Ritchie, G. S. P. 1994. Phosphorus removal from piggery effluents of varying quality using lime and physico-chemical treatment methods. Environmental Pollution, 84, 237-244.
Wei, X., Rodak, C. M., Zhang, S., Han, Y. & Wolfe, F. A. 2016. Mine drainage generation and control options. Water Environment Research, 88, 1409-1432.
Ye, Y., Ngo, H. H., Guo, W., Liu, Y., Li, J., Liu, Y., Zhang, X. & Jia, H. 2017. Insight into chemical phosphate recovery from municipal wastewater. Science of the Total Environment, 576, 159-171.

We claim:

1. A method of treating acid mine drainage comprising:
contacting acid mine drainage with a treatment agent including a compound comprising phosphate under conditions that favour removal of contaminants from the acid mine drainage, thus forming the treated acid mine drainage that has a concentration of contaminants which is less than the concentration of contaminants in the acid mine drainage prior to the treatment.

2. The method according to claim 1, wherein the compound comprising the phosphate is in a form of a synthesised compound comprising calcium phosphate.

3. The method according to claim 2, wherein the synthesised compound comprising calcium phosphate is obtained from contacting a body of contaminated water, in particular municipal waste water comprising at least one of ammonia and phosphate, with a precipitation agent selected from the group consisting of lime, hydrated lime, limestone, dolomite, magnesite, periclase, brucite, soda ash, and caustic soda, preferably hydrated lime, under conditions that favour precipitation of the synthesised compound comprising calcium phosphate from the municipal waste water.

4. The method according to claim 3, wherein the synthesised compound comprising calcium phosphate is recovered from the municipal waste water in a form of a municipal waste water sludge, wherein the method further comprises a step of recovering the municipal waste water sludge from the municipal waste water.

5. The method according to claim 4, wherein the recovered municipal waste water sludge is subjected to drying, typically under high temperature conditions, for example in an oven, to form the dried municipal waste water sludge.

6. The method according to claim 5, wherein the dried municipal waste water sludge is subjected to size reduction thus forming the municipal waste water sludge comprising a synthesised compound comprising calcium phosphate in particulate format.

7. The method according to claim 2, wherein favourable conditions which favour removal of contaminants from acid mine drainage include contacting about 1 litre of the acid mine drainage with between 0.5 g to 25 g, preferably 1 to 15 g, more preferably between 2.5 g and 10 g, more preferably 5 g and 10 g of a synthesised compound comprising calcium phosphate with the acid mine drainage, for a contact time of between 5 and 180 minutes, preferably 10 and 90 minutes, preferably between 15 and 60 minutes, more preferably between 30 and 45 minutes.

8. The method according to claim 2, wherein favourable conditions which favour removal of contaminants from acid mine drainage include contacting about 1 litre of acid mine drainage with about 10 g of a synthesised compound comprising the calcium phosphate for a contact time of about 90 minutes.

9. The method according to claim 2, further comprising a step of agitating, preferably continuously agitating, a mixture comprising a compound comprising the calcium phosphate with acid mine drainage.

10. The method according to claim 9, wherein the agitation is effected at a rotational speed of about 300 rpm.

11. A process for treating acid mine drainage comprising:
feeding, in a vessel, the acid mine drainage and a synthesised compound comprising calcium phosphate to allow contact between the acid mine drainage and the synthesised compound comprising calcium phosphate, thus forming a mixture of the acid mine drainage and the synthesised compound comprising the calcium phosphate,
wherein contact between the acid mine drainage and the synthesised compound comprising the calcium phosphate occurs under contact conditions that favour removal of contaminants from the acid mine drainage thus forming the treated acid mine drainage that has concentration of the contaminants that is lower than concentration of the contaminants in the acid mine drainage prior to the treatment.

12. The process according to claim 11, wherein the process forms acid mine drainage sludge comprising the contaminants removed from the acid mine drainage during the treatment.

13. The process according to claim 12, further includes recovering, by solid-liquid separation, the treated acid mine drainage from the acid mine drainage sludge.
